(19) United States
(12) Patent Application Publication
(10) Pub. No.: US 2007/0238078 A1
(43) Pub. Date: Oct. 11, 2007

(54) METHOD FOR TEACHING FUNDAMENTAL ABACUS MATH SKILLS

(76) Inventor: Rueyin Chiou, Tempe, AZ (US)

Correspondence Address: WEISS & MOY PC, 4204 NORTH BROWN AVENUE, SCOTTSDALE, AZ, 85251, US

(21) Appl. No.: 11/277,816

(22) Filed: Mar. 29, 2006

(51) Int. Cl. G09B 19/02

(52) U.S. Cl. 434/188

(57) ABSTRACT

A method for teaching fundamental abacus math skills by using music is disclosed. Different numbers are assigned to different musical notes. Two or more numbers are sung consecutively at the pitches of their assigned notes and a resulting sum or difference of the two or more numbers is then sung.

### FIELD OF THE INVENTION

This invention relates generally to abacuses and, more particular, to teaching fundamental abacus math skills by using music.

### BACKGROUND OF THE INVENTION

The abacus is a well-known calculation tool that has been used for thousands of years. In the past, the abacus has been utilized by merchants and others as an aid for performing mathematical calculations, such as addition, subtraction, multiplication, and division. In the modern era, the abacus has been replaced in many instances by modern calculators and/or computers. However, the abacus is not retired and is still widely used by merchants and clerks in certain parts of Asia and elsewhere, as well as for educational purposes. In this regard, the abacus may be considered an excellent tool for promoting mathematical learning and fast mind activities by young children. “Abacus math” is an arithmetic method based on the principles of abacus calculation. After a person has been working on an abacus for a period of time, a virtual mental picture of the abacus is often formed in the person's mind. The person can then use such a “virtual abacus” to perform calculations. For such a person, it would not be unusual to be able to handle at an accelerated speed a series of five or more digits in mentally performing addition, subtraction, multiplication, and/or division. It has become evident that children who receive training in abacus mental mathematics may excel in mathematics in general, as well as in other academic subjects.

Abacus math learning centers are commonly seen in Asian countries, such as Taiwan, China, Japan, Malaysia, Indonesia, and Singapore. However, the abacus education is rarely seen in the United States. A possible reason for this is that at the beginning stages of learning abacus, students need to master certain fundamental fingering and math skills pertaining to the abacus. Learning the fundamental skills is required before students can learn how to use the abacus itself. The fundamental skills are easy to recite and memorize in Chinese, for instance, because the Chinese languages always have a single syllable for a number and for each character. When translated into English, however, the fundamental skills lose the rhymes that are present when recited in Chinese. This can make it very difficult for children from non-Asian cultures to learn the fundamental skills. Furthermore, the process of learning math skills may be considered a chore that is disliked by some children. As a result, some children demonstrate resistance to learning math skills.

A need therefore exists for a method of teaching fundamental abacus math skills that is fun and suitable for children of any cultural background.

The present invention satisfies these needs and provides other, related advantages.

### SUMMARY OF THE INVENTION

In accordance with an embodiment of the present invention, a method for teaching fundamental abacus math skills is disclosed. The method comprises: for a first group of a plurality of numbers, assigning one note to each of the numbers, wherein the first group of the plurality of numbers is located in a first position; for a second group of a plurality of numbers, assigning one note to each of the numbers, wherein the second group of the plurality of numbers is located in a second position which is higher than the first position; designating one of the first group and the second group as positive numbers and the other of the first group and the second group as negative numbers; and singing a plurality of melodies comprising: singing two or more numbers consecutively, wherein each number is sung at a pitch of its assigned note and singing one of a resulting sum and difference of the two or more numbers.

In accordance with another embodiment of the present invention, a method for teaching fundamental abacus skills is disclosed. The method comprises: for a first group of a plurality of numbers, assigning one note to each of the numbers, wherein the first group of the plurality of numbers is located in a first position; for a second group of a plurality of numbers, assigning one note to each of the numbers, wherein the second group of the plurality of numbers is located in a second position which is higher than the first position; designating one of the first group and the second group as positive numbers and the other of the first group and the second group as negative numbers; singing a plurality of melodies comprising: singing two or more numbers consecutively, wherein each number is sung at a pitch of its assigned note and singing one of a resulting sum and difference of the two or more numbers; and instructing at least one student to sing the plurality of melodies.

### BRIEF DESCRIPTION OF THE DRAWINGS

FIG. 1 is a perspective view of a modem style abacus.

FIG. 2 is a pictorial diagram depicting a portion of a standard musical keyboard, with certain keys thereon designated, which may be utilized with an embodiment of the present invention.

FIG. 3 is a pictorial diagram depicting a chart of rules consistent with an embodiment of the present invention.

FIG. 4 is a pictorial diagram depicting a chart of rules consistent with an embodiment of the present invention.

### DETAILED DESCRIPTION OF THE PREFERRED EMBODIMENTS

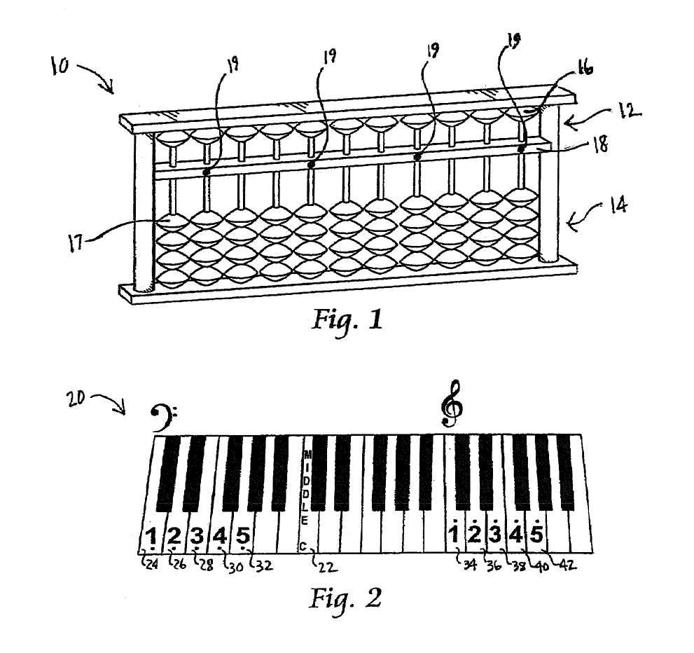

Referring first to FIG. 1, a modern style abacus 10, also known as a “Soroban,” is shown. The abacus 10 may be divided into two portions: an upper deck 12 and a lower deck 14. The upper deck 12 contains single beads 16 in a row. Each of the single beads 16 in the upper deck 12 represent a value of five. The lower deck 14 contains four beads 17 in four rows. Each bead of the four beads 17 in the lower deck 14 represents a value of one. The upper deck 12 and the lower deck 14 are separated by a beam 18 which runs horizontally across the abacus. The beam 18 includes a plurality of markings 19 which designate decimal point and/or comma separators. To count by using the abacus 10, a person moves the four beads 17 and the single beads 16 toward the beam 18. As an example, to represent the number four, the four beads 17 in the farthest-right column would be pushed toward the beam 18. To represent the number five, the single bead 16 in the farthest-right column would be pushed toward the beam 18 and the four beads 17 in the farthest-right column would be pushed back away from the beam 18. To represent the number seven, the single bead 16 in the farthest-right column would be pushed toward the beam 18 and two of the four beads 17 in the farthest-right column would be pushed toward the beam 18. In order to properly use the abacus 10, at a minimum, one should be proficient in simple math skills involving the addition and subtraction of single digit numbers. As an example, in order to accurately represent the number seven on an abacus 10, a user would need to know that the sum of five and two is seven. In this regard, after pushing the single bead 16 in the farthest-right column toward the beam 18, a user would need to know how many of the four beads 17 in the farthest-right column are necessary to represent the number seven. Further, in order to represent numbers greater than five by using the farthest-right column of the abacus 10, a user would need to know the following equations: 5+1=6, 5+2=7, 5+3=8, and 5+4=9.

Referring now to FIG. 2, a portion of a standard musical keyboard 20 is shown. Middle C 22 is shown on the keyboard 20. In this embodiment, a first group of five keys 24, 26, 28, 30 and 32 on the keyboard 20 are selected in sequence corresponding to an octave that is below middle C 22. In this embodiment, the first group of five keys 24, 26, 28, 30 and 32 correspond to the notes c, d, e, f and g, respectively. However, other sequential notes could be used for the first group of five keys 24, 26, 28, 30 and 32, such as: d, e, f#, g and a; e, f#, g#, a and b; etc. A different number from one to five is designated for each of the five keys 24, 26, 28, 30 and 32. As shown in FIG. 2, the number 1 is designated for key 24, the number 2 for key 26, the number 3 for key 28, the number 4 for key 30, and the number 5 for key 32. Preferably, the first group of five keys 24, 26, 28, 30 and 32 represent negative numbers.

Also in this embodiment, a second group of five keys 34, 36, 38, 40, and 42 on the keyboard 20 are selected in sequence corresponding to an octave that is above middle C 22. In this embodiment, the second group of five keys 34, 36, 38, 40 and 42 correspond to the notes c′d′, e′, f′ and g′, respectively. However, other sequential notes could be used for the second group of five keys 34, 36, 38, 40 and 42, such as: d′, e′, f#′, g and a′; e′, f#′, g#′, a and b; etc. A different number from one to five is designated for each of the five keys 34, 36, 38, 40 and 42. As shown in FIG. 2, the number 1 is designated for key 34, the number 2 for key 36, the number 3 for key 38, the number 4 for key 40, and the number 5 for key 42. Preferably, the second group of five keys 34, 36, 38, 40 and 42 represent positive numbers. While in this embodiment the first group of five keys correspond to an octave that is below middle C and the second group of five keys correspond to an octave that is above middle C, both groups could be located either below or above middle C.

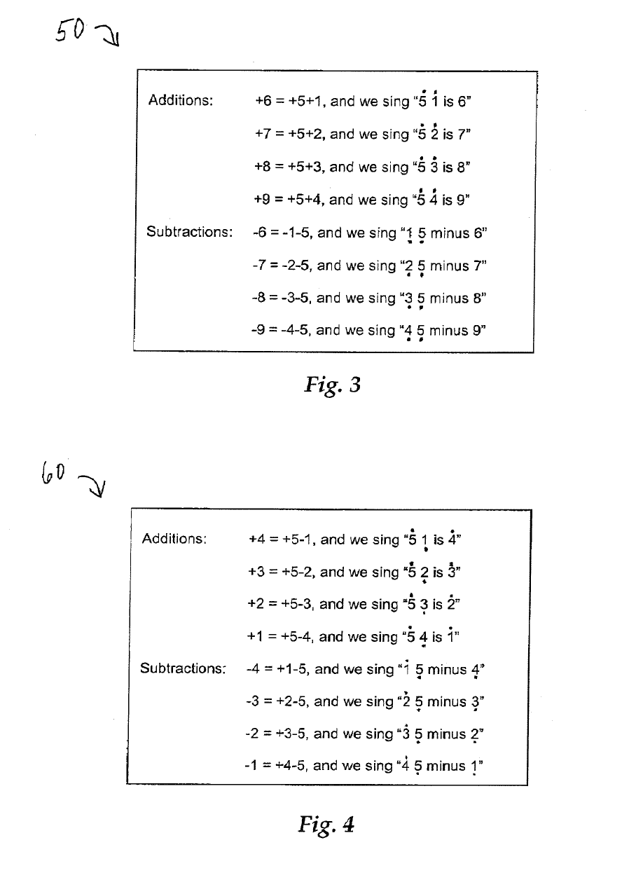

Referring now to FIGS. 3 and 4, charts 50 and 60 display exemplars of several basic equations that are necessary in order to properly use an abacus, as well as preferred ways to sing the equations. By learning the equations on the charts 50 and 60, as well as other similar equations, a student would eventually learn fundamental abacus math skills. Preferably, a student would learn the sum of two different numbers by singing a melody in which the numbers are sung in sequence at their assigned pitches and then the resulting sum of those numbers is sung. As an example, as best shown in FIGS. 2 and 3, for the sum of the numbers one and five, a student would sing “5 1 is 6,” with the number five being sung at a pitch of g and the number one being sung at a pitch of c. As another example, as best shown in FIGS. 2 and 3, for the sum of the numbers three and five, a student would sing “5 3 is 8,” with the number five being sung at a pitch of g and the number three being sung at a pitch of e. Similarly, a student would learn the difference of two different numbers by singing a melody in which the numbers are sung in sequence at their assigned pitches and then the resulting difference of those numbers is sung. As an example, a student may learn the difference between the numbers five and one by singing “5 1 is 4,” with the number five being sung at a pitch of g and the number 1 being sung at a pitch of c. In this embodiment, the melodies are sung in the key of C major, but other keys and/or modes could also be used. Through exposure to the melodies—by hearing them and singing them—a student will eventually memorize the sums and differences of different sets of two or more numbers. In this way, a student will become proficient in simple math skills involving the addition and subtraction of single digit numbers, and accordingly, will be prepared to begin using the abacus, as described above.

While the invention has been particularly shown and described with reference to the preferred embodiments thereof, it will be understood by those skilled in the art that the foregoing and other changes in form and details may be made therein without departing from the spirit and scope of the invention. For example, it may be desired to employ the melodies to teach multiplication and/or division skills. It may also be desired to assign the groups of numbers to notes within certain vocal ranges, such as alto or soprano, depending on the vocal ranges of the students being instructed by the method of the present invention.

I claim:

1. A method for teaching fundamental abacus math skills comprising:
for a first group of a plurality of numbers, assigning one note to each of the numbers, wherein the first group of the plurality of numbers is located in a first position;
for a second group of a plurality of numbers, assigning one note to each of the numbers, wherein the second group of the plurality of numbers is located in a second position which is higher than the first position;
designating one of the first group and the second group as positive numbers and the other of the first group and the second group as negative numbers; and
singing a plurality of melodies comprising:
singing two or more numbers consecutively, wherein each number is sung at a pitch of its assigned note; and
singing one of a resulting sum and difference of the two or more numbers.

2. The method of claim 1 wherein the first group comprises five numbers.

3. The method of claim 1 wherein the second group comprises five numbers.

4. The method of claim 1 wherein the first group is designated as negative numbers and the second group is designated as positive numbers.

5. The method of claim 1 wherein the first group comprises single-digit numbers.

6. The method of claim 1 wherein the second group comprises single-digit numbers.

7. The method of claim 1 wherein the plurality of melodies is sung in a major key.

8. The method of claim 1 wherein the plurality of melodies is sung in a minor key.

9. A method for teaching fundamental abacus math skills comprising:
for a first group of a plurality of numbers, assigning one note to each of the numbers, wherein the first group of the plurality of numbers is located in a first position;
for a second group of a plurality of numbers, assigning one note to each of the numbers, wherein the second group of the plurality of numbers is located in a second position which is higher than the first position;
designating one of the first group and the second group as positive numbers and the other of the first group and the second group as negative numbers;
singing a plurality of melodies comprising:
singing two or more numbers consecutively, wherein each number is sung at a pitch of its assigned note; and
singing one of a resulting sum and difference of the two or more numbers; and
instructing at least one student to sing the plurality of melodies.

10. The method of claim 9 wherein the first group comprises five numbers.

11. The method of claim 9 wherein the second group comprises five numbers.

12. The method of claim 9 wherein the first group is designated as negative numbers and the second group is designated as positive numbers.

13. The method of claim 9 wherein the first group comprises single-digit numbers.

14. The method of claim 9 wherein the second group comprises single-digit numbers.

15. The method of claim 9 wherein the plurality of melodies is sung in a major key.

16. The method of claim 9 wherein the plurality of melodies is sung in a minor key.
